(19) United States
(12) Patent Application Publication
(10) Pub. No.: US 2024/0104406 A1
(43) Pub. Date: Mar. 28, 2024

(54) Method for automatically generating a decision making assistance algorithm; computer program product and associated computer device

(71) Applicant: THALES, COURBEVOIE (FR)

(72) Inventors: Thomak LEDUC, MERIGNAC (FR); Jaime DIAZ PINEDA, MERIGNAC (FR); Maelle ANDRICQUE, MERIGNAC (FR)

(21) Appl. No.: 18/470,418

(22) Filed: Sep. 20, 2023

(30) Foreign Application Priority Data
Sep. 27, 2022 (FR) 2209773

(51) Int. Cl. G06N 5/025

(52) U.S. Cl. CPC G06N 5/025

(57) ABSTRACT

A method includes providing logical rules each associating a piece of knowledge with a physical datum or data, analyzing the provided logical rules in order to extract a set of knowledge and a set of physical data; developing a network of logical tensors including a neural network for each piece of knowledge and a neural network for each physical datum, a neural network calculating a relevance of the piece of knowledge or of the associated physical datum from a current situation, defined by the current values of the physical data, training the network on a learning database, and executing the decision-making aid algorithm resulting from the learning phase on a new situation, in order to calculate the relevance of each piece of knowledge and each physical datum with respect to the new situation.

### REFERENCE TO RELATED APPLICATION

This application is a U.S. non-provisional application claiming the benefit of French Application No. 22 09773, filed on Sep. 27, 2022, the contents of which are incorporated herein by reference in their entirety.

### TECHNICAL FIELD OF THE INVENTION

The field of the present invention is the field of assisting operators in decision-making in complex and dynamic environments, in particular assisting pilots of civil or military aircraft in decision-making.

### BACKGROUND OF THE INVENTION

For decision-making in a complex and dynamic environment, the operator has to manage, under a strong time constraint, a large quantity of data describing the environment, only a part of which is relevant for making a decision suitable for the particular situation s encountered at the current moment.

Making a suitable decision then depends on the situational awareness of the pilot about the environment.

Situational awareness can be defined as a three-level cognitive mechanism: (1) the perception of the elements of the environment, (2) the understanding of the meaning thereof and finally (3) the projection of the future state of the significant elements.

Such model highlights how the pilot captures environmental description data and analyzes such data in order to make decisions. The model applies well to the case of pilots on commercial flights, a use case where such model has been the subject of many validations.

However, while focusing on the mission to be carried out, the pilot could be led not to consider a datum because the datum is not significant for the mission to be carried out, whereas the datum is significant for the current situation. More generally, due to factors such as workload, stress, or simply distraction or fatigue, the pilot may ignore or forget information that would have allowed him/her to have a better situational awareness in order to cope with a situation.

It is clear that not taking into account certain environmental data in the first steps of the model can lead to a mistaken awareness of the situation and thus to inappropriate decision-making.

In some operational phases, an issuing operator, such as the pilot, is required to share environmental description data with a receiving operator, such as the co-pilot (or the air traffic controller). Such communications constrain the amount of information to be shared. The issuing operator does not share all the environmental description data with the other operator but chooses to share some data that the operator knows to form a shared basis for common situational awareness. However, the issuing operator could overload the information communicated by adding unnecessary information, due to a lack of filtering of the available information on his/her part.

There is thus a problem related to the ability of the operator to master the relevant information about the particular situation encountered.

To ensure the performance of decision-making in a complex and dynamic environment, it is necessary to provide the availability of relevant knowledge without overloading pilots with information which is not needed.

It is necessary to reduce the amount of information from the environment by describing and assessing the relevance of the information through a decision support system.

However, the occurrence of a situation requires rapid decision-making. For this reason, decision support systems have to optimize the calculations thereof and provide the pilot with the relevant information in real time for his/her understanding of the situation and his/her decision-making.

### SUMMARY OF THE INVENTION

The goal of the present invention to solve such problem.

For this purpose, the subject matter of invention is a method for automatically generating an algorithm for assisting the decision making by an operator in a complex and dynamic environment, characterized in that the method includes the steps of: providing a knowledge base including a plurality of logical rules, a logical rule being a logical function associating a piece of knowledge with one or a plurality of input variables, an input variable being a physical datum and/or intermediate knowledge; analyzing the knowledge base in order to extract a knowledge set and a set of physical data; developing a logic tensor network algorithm including a neural network for each piece of knowledge of the knowledge set and a neural network for each physical datum of the set of physical data, a neural network calculating the relevance of the piece of knowledge or of the associated physical datum from a current situation, the current situation being defined by the current values of each physical datum in the physical data set; training the logical tensor network algorithm on a learning database including annotated situations with the true relevance of each piece of knowledge and of each physical datum, in order to obtain the decision-making aid algorithm; and, executing the decision-making aid algorithm on a new situation, for calculating the relevance of each piece of knowledge and of each physical datum with respect to the new situation.

According to particular embodiments, the method includes one or more of the following features, taken individually or according to all technically possible combinations:
analyzing the knowledge base makes it possible to extract, for each piece of knowledge of the set of knowledge, a set of causes of said knowledge, which consists of physical data which are the direct or indirect causes of said knowledge, and wherein the training of the logical tensor network type algorithm is carried out by implementing a constraint based on all the causes of each piece of knowledge.
the training of the logical tensor network algorithm is performed by minimizing a global truth value resulting from an aggregation of a plurality of elementary truth values, where the plurality of elementary truth values includes: at least the relevance of a physical datum for any situation such that said physical datum is annotated as relevant; at least the relevance of a physical datum for any situation such that said physical datum is annotated as not relevant; and, for each piece of knowledge, at least one difference between the relevance of said knowledge and the logical disjunction of the relevance of all the causes of said knowledge.
the environment is the environment of an aircraft and the operator is the pilot of said aircraft.
following the execution of the decision-making aid on the new situation, the method includes a step consisting of presenting the operator with a list of knowledge and/or data filtered and/or ordered depending on the respective relevance thereof.

A further subject matter of the invention is a computer program product including software instructions which, when executed by a computer device, implement a decision-making aid algorithm resulting from the implementation of the previous method.

A further subject matter of the invention is a device configured so as to execute the decision-making aid algorithm resulting from the implementation of the preceding method.

### BRIEF DESCRIPTION OF THE DRAWINGS

The invention and the advantages of the invention will be better understood upon reading the following detailed description of the different embodiments of the invention, given only as examples and not limited to, the description being made with reference to the enclosed drawings, wherein:

FIG. 1 is a block representation of an embodiment of the identification method according to the invention; and

FIG. 2 is a schematic representation of the system for the implementation of the identification method according to the invention.

### DETAILED DESCRIPTION OF EMBODIMENTS

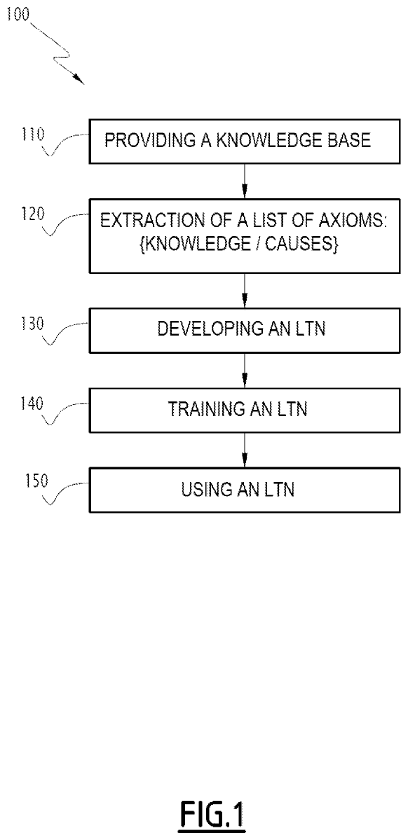

FIG. 1 illustrates a preferred embodiment of a method 100 for developing an algorithm for assisting the decision-making by an operator in a complex and dynamic environment.

Such method is executed on a suitably programmed computer.

The algorithm developed is based on a neuro-symbolic architecture, bringing together the semantic aspect of symbolic artificial intelligence and the performance of neural networks.

During a step 110, a knowledge base is provided. In the example of the present embodiment, it is a meteorological knowledge base.

The knowledge base is, e.g., a database prepared by experts, herein meteorologists and aircraft pilots.

The knowledge base can take different forms. For example, it is a text file. In a variant, it is an ontology, i.e., a structured set of concepts and relationships between concepts, which offers a modeling of a field of knowledge, in the present case the meteorological field.

The knowledge base has logical rules. The rules are rules of thumb defined by experts in the field.

A rule is a logical function taking as input, the current values of a set of input variables and delivering as output, the truth value of a piece of knowledge.

The set of input variables includes one or a plurality of physical data and/or one or a plurality of intermediate knowledge.

A physical datum d is a quantity the instantaneous value of which is measured by a system, on-board the aircraft or remotely.

The set S of measured physical data d is used for describing the environment.

A situation s consists of the instantaneous values of the physical data of the set S.

A piece of knowledge k is an element of interpretation giving an abstract representation of the environment. A piece of knowledge has a semantic dimension. Semantics gives meaning to a sign (like a word) depending on the context.

The set K of knowledge k gives a high-level objective representation of the environment. More precisely, the instantaneous truth values of all knowledge k of the set K form an objective representation of the situation. The above is different from situational awareness, which concerns the interpretation an operator gives to the situation, i.e., subjective representation of the situation.

For example, the knowledge base stores a first set of rules relating to the piece of knowledge “Icing”. The first set includes, e.g., the rule:
“Air_temp<0° C.=>Icing”

Thereby, the fact that the value at the current instant of the physical data “air temperature”, Air_temp, is effectively less than 0° C., leads to the piece of knowledge of a risk of icing (i.e., that the current truth value of the piece of knowledge “Icing” takes the value one).

The knowledge base stores a second set of rules relating to knowledge “Heat”. The second set includes, e.g., the rule:
“Air_temp>20° C.=>Heat”

Thereby, the fact that the value at the current moment of the physical datum “air temperature”, Air_temp, is actually greater than 20° C., leads to the piece of knowledge that it is hot (i.e., the current truth value of the piece of knowledge “Heat” takes the value one).

The knowledge base stores a third set of rules relating to the piece of knowledge “Wind”. The third set of rules includes, e.g., the rules:
“Wind_speed>30 kn=>Wind”

Thereby, the fact that the value at the current instant of the physical data “wind speed”, Wind_speed, is actually greater than 30 kn, leads to the piece of knowledge that there is wind (i.e., the current truth value of the piece of knowledge “wind” takes the value one).
‘Wind_speed>10 kn AND Wind_direction>220°
   AND Wind_direction<320° _>Wind”

Thereby, the fact that at the current instant, the value of the physical datum “wind speed”, Wind_speed, is greater than 10 kn and that the value of the physical datum “wind direction”, Wind_direction, is between 220° and 320° (with respect to the longitudinal direction of the aircraft) leads to the piece of knowledge that there is wind (i.e., the truth value of the piece of knowledge “Wind” takes the value one).
‘Wind_speed<10 kn AND Wind_speed_gust<10 kn=>NOT wind’

Thereby, the fact that the current value of the physical datum “wind speed”, Wind_speed, is less than 10 kn and that the current value of the physical datum “wind gust speed”, Wind_speed_gust, is less than 10 kn leads to the piece of knowledge that there is no wind (i.e., the truth value of the piece of knowledge “NOT wind” takes the value one, or the truth value of the piece of knowledge “wind” takes the value zero).
“Heat=>Wind”

Thereby, the piece of knowledge of the fact that it is hot (the current truth value of the intermediate knowledge “Heat” taking the value one) leads to the piece of knowledge that there is wind (i.e., the current truth value of the piece of knowledge “wind” takes the value one).

During a step 120, the knowledge base analyzed in order to determine the set K of the piece of knowledge, the set S of the physical data describing the environment, and, advantageously, for each piece of knowledge k of the set K, the set Sk of the physical data (or causes) which affect the piece of knowledge k, whether directly or indirectly through one or a plurality of intermediate pieces of knowledge.

The set Sk of causes of knowledge k is a subset of the set S.

For example, for the previous three sets of rules, the result of such analysis step is summarized by the following table:

| Knowledge | Cause(s) |
|---|---|
| Icing | Air_Temp |
| Heat | Air_Temp |
| Wind | Wind_speed |
| | Wind_direction |
| | Wind_speed_gust |
| | Air_Temp |

Thereby, for the present example, the set K of knowledge k consists of the piece of knowledge “Icing”, “Heat” and “Wind”.

Thereby, the set S of the physical data d consists of the data “Wind_speed”, “Wind_direction”, “Wind_speed_gust” and “Air_temp”.

All causes associated with the piece of knowledge “Icing” include the physical data “Air_temp”, all causes associated with the piece of knowledge “Heat” include the physical datum “Air_temp”, and all causes associated with the piece of knowledge “Wind” include the physical data “Wind_speed”, “Wind_direction”, “Wind_speed_gust” and “Air_temp”.

Thereby, the physical datum of air temperature, Air_temp, is a cause of the piece of knowledge “Icing”, and also of the piece of knowledge “Heat” and of the piece of knowledge “Wind”.

The next step 130 is an encoding step for building the architecture of an LTN algorithm.

We note by Pₖ(s) the relevance of the piece of knowledge k with respect to the situation s (i.e., the current values of the physical data of the set S).

The relevance is a variable between 0 and 1. When the relevance Pₖ(s) is close to one, the current values of the physical data of the set S are such that the relevance of the piece of knowledge k is acquired. When the relevance Pₖ(s) is close to zero, the current values of the physical variables of the set S are such that the relevance of the piece of knowledge k is not acquired.

In the common use case, the truth value of knowledge k and the relevance value of knowledge k are very similar, but this is not necessarily the case. For example, we consider that a truth value equal to 1 for the piece of knowledge “Heat” indicates that it is very hot and a truth value equal to 0 indicates that it is very cold. The piece of knowledge “Heat” is considered to be relevant when the truth value thereof approaches either of the extremes (0 or 1) thereof. The piece of knowledge “Heat” is then very relevant (relevance value close to 1) when the truth value thereof is close to 0.

Similarly, P_{d}(s) denotes the relevance of the physical datum d with respect to the situation s.

An LTN algorithm is an algorithm of the Logic Tensor Networks (LTN) family.

The LTN algorithm is implemented, for example, using the free software “Tensorflow” (registered trademark) and the interface “Python” (registered trademark) thereof.

In general, an LTN algorithm is based on logic derived from first order logic and from fuzzy logic. The LTN algorithm is used for converting a logical function into an object called a computational graph in the “Tensorflow” software. The function is broken down into elementary predicates and the following principles are applied:
constants and variables are represented by tensors;
the elementary predicates associating the constants and the variables are represented by a function which can be a neural network; and,
the logical operators between elementary predicates are represented by fuzzy logic operators.

In the present method, the LTN algorithm is constructed so as to associate a neural network with each piece of knowledge k of the set K and a neural network with each physical datum d of the set S.

The neural network associated with the piece of knowledge k is used for approximating the relevance Pₖ(s). Therefore, the neural network takes as input the situation s and delivers as output the relevance of the piece of knowledge k with respect to the situation s.

The neural network associated with the physical datum d is used for approximating the relevance P_{d}(s). Same thus takes as input the situation s and delivers as output the relevance of the datum d with respect to the situation s.

The input of a neural network is a tensor the coordinates of which are the current values of the data of the set S.

In the example hereinabove, since the set S consists of the data “Wind_speed”, “Wind_direction”, “Wind_speed_gust” and “Air_temp”, the input tensor (30, 90, 30, 5) corresponds to the situation s wherein:
the wind speed is equal to 30 kn
the wind direction makes an angle of 90°
the gust speed is 35 kn
the air temperature is equal to 5° C.

During a step 140, the parameters of the LTN algorithm are suitably established by the implementation of a training phase.

The training uses batches of labeled situations, i.e., situations s annotated with the true value of the relevance of the different pieces of knowledge k of the set K and the true value of the relevance of the different data d of the set S. A training database is used, which includes labeled situations. The database is, e.g., developed from real situations annotated by experts.

The training is used for adjusting the parameters of the different neural networks of the LTN algorithm so that the relevancies estimated by each of the neural networks fit the annotations.

Preferentially, the training consists of maximizing a global truth value resulting from the aggregation of a plurality of elementary truth values. An aggregation is, e.g., the product of elementary truth values.

The plurality of elementary truth values includes:
the truth value equal to P_{d}(s) for any situation s such that the physical datum d is annotated as relevant;
the truth value equal to Not P_{d}(s) for any situation s such that the physical datum d is annotated as not relevant; and, advantageously; and,
for each piece of knowledge k of the set K, the truth value equal to 1−Pₖ(s)+U_{d∈s}_{^{k}}P_{d}(s), which reflects the axiom Pₖ(s)⇔U_{d∈S}_{^{k}}P_{d}(s), where “U” is the logical disjunction operator which is applied to all the physical data d of the set Sₖ of the causes of the piece of knowledge k (determined during step 120). The axiom reflects the fact that the relevance of the piece of knowledge k for a situation s is equivalent to the combination of the relevance for the situation s of each of the causes d of the piece of knowledge k.

A person skilled in the art will note that the contribution of logical rules in learning is made through the constraints formulated by the elementary truth values. In a variant, other constraints (alternatives to the previous constraints or additional to the previous constraints) could be developed from the relevance of the data and/or of knowledge.

At each training step of the LTN algorithm, the global truth value is calculated for an annotated situation s. A conventional gradient descent is preferentially used with a cost function equal to one minus the global truth value.

Among the set S of the data d, it will be mainly the data d of the set Sk of the causes of the piece of knowledge k which will influence the result of the calculation of the relevance of the piece of knowledge k, but it is possible that the training “discovers” new correlations between data and knowledge, i.e., correlations which were not present in the knowledge base initially provided. It is conceivable to enrich the initial knowledge base with new rules reflecting such new correlation.

Once the LTN algorithm is trained, the algorithm is none other than the decision-making aid algorithm which is possible to use, during a step 150, for reasoning on new situations.

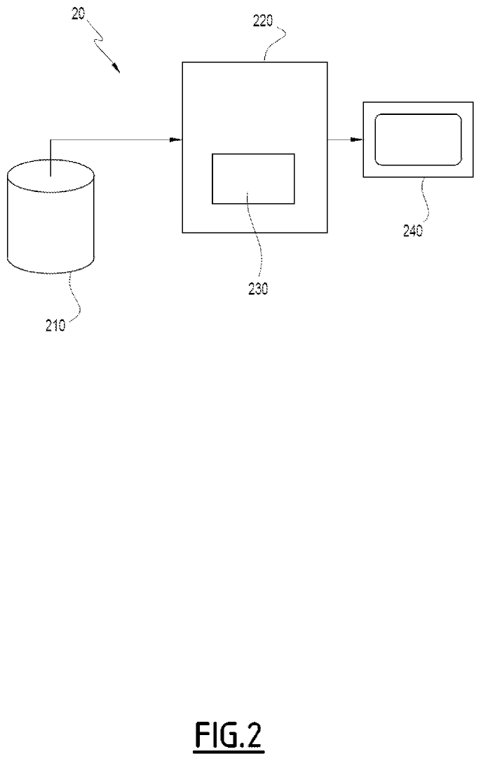

The algorithm is downloaded to a decision-making aid, computer device on-board the aircraft. The above is illustrated by the device 200 of FIG. 2, which is suitable for executing the algorithm 230. The device is connected to sensors or systems (referenced generally by the number 210 in FIG. 2) for the acquisition of instantaneous values of the physical data forming the inputs of the algorithm.

For a given situation, the decision-making aid algorithm calculates the relevance of each piece of knowledge k by executing the corresponding neural network and the relevance of each physical datum d by executing the corresponding neural network.

The ability to obtain the relevance of each physical datum leads to a better explicability of the results concerning the piece of knowledge. Indeed, it is thereby possible to determine which physical datum has influenced the result, e.g., the relevance of the piece of knowledge k.

For example, by considering the piece of knowledge “Wind” and the causes thereof “wind speed”, “wind direction”, “gust speed”, and “air temperature” after training, the relevance of each of the five pieces of information can be obtained.

The relevance of each physical datum can be used for determining which physical datum/data have actually influenced the relevance of the piece of knowledge wind.

For example:
the relevance of the wind is high and the relevance of each of the four physical data is high, then each of the four data influenced the result in a similar way;
the relevance of the wind is low and the relevance of each of the four physical data is low, then each of the four data influenced the result in a similar way;
the relevance of the wind is high and the relevance of one of the physical data is high, the others remaining low, so said physical datum influenced the result more strongly than the others.

It is theoretically impossible that the relevance of a cause is high and the relevance of the piece of knowledge is low. The use of the disjunction logical operator implies the above property.

The outputs of the aid algorithm can be used in different ways. For example, knowledge, the relevance of which is greater than a threshold, is displayed on a screen 240 of the decision-making aid computer device 200. The pilot is thereby informed of the piece of knowledge associated with the current situation. Hence, the pilot has an objective representation of the situation.

In a variant, physical data having a relevance greater than a threshold are displayed. The pilot's attention is then drawn to the significant information in relation to the current situation. It is then up to the pilot to develop his/her own representation of the situation, from objectively filtered information. The above lightens the cognitive load of the pilot. In this way it is possible to reduce the amount of information the operator has to take into account by releasing at each moment only the information known to be useful (i.e., the physical data influencing the piece of knowledge relevant to the situation encountered).

Alternatively, the physical data are ordered according to the current relevance so as to present to the pilot first of all, the data which have the greatest influence on the understanding of the current situation or which are to be shared with other crew members in order to develop a common situational awareness.

The present solution can be used for meeting the constraints of execution time. Therefore, same is compatible with real time. Indeed, the architecture on which the solution is based has the following advantages:
compared to deep learning systems, the solution requires less training data, while providing better generalization, interpretability and explicability of results.
compared to symbolic artificial intelligence systems, the solution runs faster, with the possibility of working with erroneous or incomplete knowledge base s and of extracting new knowledge.

In addition, after training, only trained neural networks need to be on-board. The resources required are thus low, both in terms of storage memory, computing capacity or execution time. In this way, it is possible to satisfy both the constraints of presence on-board and real time.

The proposed solution has good results even with a reduced training base. Indeed, convincing results were obtained with 60 labeled situations in the training base and 30 training periods, meaning a training time of about fifteen seconds. Since the development of a training database is a tedious task, it is a decisive advantage that the algorithm according to the invention can be trained efficiently with a small number of data.

The proposed solution makes it possible to take into account field-specific knowledge in machine learning, through the analysis of an existing knowledge base.

It is easy to adapt the aid algorithm to any modification of the initial knowledge base. Therefore, the present solution has a dynamic dimension.

The symbolic aspect induces a semantic dimension which gives meaning to the results obtained. This explicability or interpretability of the results helps in certifying the developed solution.

The invention can be used in environments other than civil or military avionics: autonomous car control, sensor service management in airborne surveillance, resource distribution, computer at the periphery of a network, etc.

1. A method for automatically generating an algorithm for aiding an operator in a complex and dynamic environment, the method comprising:
providing a knowledge base comprising a plurality of logical rules, a logical rule being a logical function associating a piece of knowledge with one or a plurality of input variables, an input variable being a physical datum or an intermediate piece of knowledge;
analyzing the knowledge base in order to extract a set of knowledge and a set of physical data;
developing a logic tensor network algorithm including a neural network for each piece of knowledge of the knowledge set and a neural network for each physical datum of the physical data set, a neural network calculating a relevance of the piece of knowledge or of the physical datum from a current situation, the current situation being defined by the current values of each physical datum of the set of physical data;
training the logical tensor network algorithm on a learning database including situations labelled with the true relevance of each piece of knowledge and of each physical datum, in order to obtain the decision-making aid algorithm; and
executing the decision-making aid algorithm on a new situation, in order to calculate the relevance of each piece of knowledge and of each physical datum in relation to the new situation.

2. The method according to claim 1, wherein analyzing the knowledge base makes it possible to extract, for each piece of knowledge of the set of knowledge, a set of causes of the knowledge, which comprises physical data which are the direct or indirect causes of the knowledge, and wherein the training of the logical tensor network type algorithm is carried out by implementing a constraint based on all the causes of each piece of knowledge.

3. The method according to claim 2, wherein the training of the logical tensor network algorithm is performed by minimizing a global truth value resulting from an aggregation of a plurality of elementary truth values, the plurality of elementary truth values including:
at least the relevance of a physical datum for any situation such that the physical datum is annotated as relevant;
at least the relevance of a physical datum for any situation such that the physical datum is annotated as not relevant; and
for each piece of knowledge, at least one difference between the relevance of the piece of knowledge and the logical disjunction of the relevance of all the causes of the piece of knowledge.

4. The method according to claim 1, wherein the environment is the environment of an aircraft and the operator is the pilot of the aircraft.

5. The method according to claim 1, wherein, following the execution of the decision-making aid on the new situation, the method further comprises presenting the operator with a list of knowledge and/or data filtered and/or ordered according to the respective relevance thereof.

6. A computer program product comprising software instructions which, when executed by a computer, implement a decision-making aid algorithm resulting from a method according to claim 1.

7. A decision-making aid computing device configured for executing the decision-making aid algorithm resulting from the method according to claim 1.
